(19) United States
(12) Patent Application Publication
(10) Pub. No.: US 2006/0172743 A1
(43) Pub. Date: Aug. 3, 2006

(54) Detecting the location of mobile radio subscribers who are to be monitored

(75) Inventors: Leopold Murhammer, Wien (AT); Bernhard Spalt, Wien (AT)

Correspondence Address: MORRISON & FOERSTER LLP, 1650 TYSONS BOULEVARD, SUITE 300, MCLEAN, VA, 22102, US

(73) Assignee: Siemens Aktiengesellscaft, Munchen (DE)

(21) Appl. No.: 10/548,295

(22) PCT Filed: Feb. 4, 2004
(86) PCT No.: PCT/EP04/01064

§ 371 Date: Sep. 6, 2005

(30) Foreign Application Priority Data
Mar. 6, 2003 (DE) 103 09 882.8

(51) Int. Cl. H04Q 7/20

(52) U.S. Cl. 455/456.1; 455/433

(57) ABSTRACT

An improved surveillance of subscribers of a mobile radio network by a monitoring center is made possible by a method for monitoring a subscriber of a mobile radio network. According to this method, a switching facility requests location data from a subscriber location data service facility, and after obtaining location data, sends this data in a in a monitoring information packet to a montioring center.

The invention relates to methods and devices for monitoring subscribers in a mobile radio network.

It is known from the publications TS33.107 and TS33.108 (see www.etsi.org/www.3gpp.org), which are hereby defined by reference as being part of the application, that during the interception of data (voice data/short message data/other data) of a mobile radio subscriber to be monitored in a mobile radio network by a (generally state-run) interception center, a switching facility (e.g. VMSC/GMSC/HLR or SGSN/GGSN, via which data of the subscriber to be monitored is transmitted) in addition to this data also transmits location data relating to the current or last recorded location of the subscriber to the data center in an IRI data set. This location information can also optionally be delivered via/as HI3 (handover interface 3)/CC (content of communication). With CS (circuit switched transmission) for example via UUS2 or UUS3; with PS (packet switched transmission) as part of the additional interception header. The location data transmitted in the interception-related information packet IRI represents the location information of the mobile radio subscriber in the form of cell information details (VMSC address available to the switching facility or requested by the switching facility from a home register (HLR/HSS) of the mobile radio network), which indicates the cell or cell group in which the mobile radio subscriber last registered.

The object of the invention to improve the supply of mobile radio subscriber location data to interception centers. The object is achieved respectively by the subject matter of the independent claims.

By inserting () location data requested from a subscriber location data service facility (GMLC/LCS) into an interception-related information data packet IRI/CC to be transmitted to an interception center, the invention allows the interception center to be informed more precisely about the last known location of subscribers, whose data (call data/SMS/MMS/other data) is to be monitored.

According to one embodiment of the invention the switching facility can thereby delay the sending of an interception-related information data packet IRI to an interception center MC, until it receives location data relating to a subscriber and to be inserted into the interception-related information packet IRI from a subscriber location data service facility (GMLC/LCS etc.).

Alternatively a switching facility can also not delay the sending of interception-related information packets IRI to be sent as hitherto and instead, on receipt of location data relating to the location of a subscriber to be intercepted, send an—if necessary further—interception-related information packet IRI to an interception center MC, which has the advantage that the interception center receives a first interception-related information packet IRI at an early stage.

Subscriber location data via H13/CC can be delivered in the case of a PS transmission with the next possible monitored packet in the header and in the case of CS transmission with UUS2 or UUS3.

Further features and advantages will emerge from the claims and the description which follows of an exemplary embodiment with reference to the drawing, in which:

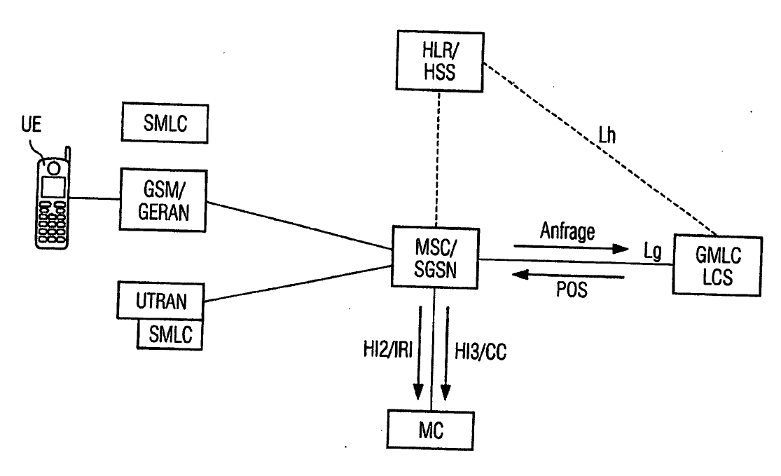

FIG. 1 shows a schematic diagram of the components of a mobile radio network involved in intercepting a subscriber in a mobile radio network and an interception center.

FIG. 1 shows a switching facility (VMSC/GMSC/HLR or SGSN/GGSN etc.), which is to monitor data (voice data/SMS/MMS/other data) of a mobile radio subscriber UE to be transmitted via it, by for example sending a copy of it to a monitoring center MC. It is known that the switching facility MSC/SGSN also transmits a data packet IRI containing interception-related information, in particular position data, relating to the subscriber UE to the monitoring center MC 3. According to the invention the switching facility MSC/SGSN monitoring the subscriber requests data representing the current or last known location of the subscriber to be monitored (via an Lg interface, etc.) from a subscriber location data service facility in a request and when location data POS from the subscriber location data service facility GMLC/LCS reaches the switching facility MSC/SGSN, it is inserted by the switching facility MSC/SGSN or another component of the mobile radio network or intercepting components connected to the mobile radio network into an interception-related information packet IRI to be transmitted to the interception center MC.

The switching facility MSC/SGSN can thereby delay the sending of an interception-related information packet IRI, until it receives location data to be inserted therein from a subscriber location data service facility GMLC/LCS or alternatively (does not delay the sending of the interception-related information packet IRI and) on receipt of location data from a subscriber location data service facility GMLC/LCS can send an—if necessary further (if one has already been sent) interception-related information packet IRI to an interception center MV.

The invention is particularly suitable for cellular mobile radio networks such as (but not exclusively) GSM networks, 3G networks, etc. and for legal reasons should only be implemented using authorized official interception centers.

### LIST OF ABBREVIATIONS

CC Content of Communication
GERAN GSM EDGE Radio Access Network
GGSN Gateway GPRS Support Node
GMLC Gateway Mobile Location Center
GMSC Gateway MSC
GPRS General Packet Radio Service
HLR Home Location Register
HI Handover Interface
HSS Home Subscriber Service
IRI Interception Related Information
LCS Location Services
MC Monitoring Center
MSC Mobile Switching Center
SGSN Serving GPRS Support Node
UE User Equipment
UUS User to User Signaling
UTRAN UMTS Terrestrial Radio Access Network
VMSC Visited MSC

1. Method for monitoring a subscriber (UE) in a mobile radio network, in which a switching facility (VMSC/GMSC/HLR/SGSN/GGSN) requests location data (POS) from a subscriber location data service facility (GMLC/LCS) (request) and on receipt of location data (POS), sends this (POS) in an interception-related information packet (HI2/IRI; HI3/CC) to an interception center (MC).

2. Method according to claim 1, wherein the switching facility (MSC/SGSN) delays the sending of an interception-related information packet (HI2/IRI; HI3/CC) until it (MSC/SGSN) receives location data (POS) to be inserted into it (HI2/IRI; HI3/CC).

3. Method according to claim 1, wherein the switching facility (MSC/SGSN) does not delay the sending of a current information packet (HI2/IRI; HI3/CC) until it receives location data (POS) but on receipt of location data (POS) in any case sends an—if necessary further—interception-related information packet (HI2/IRI; HI3/CC) to an interception center (MC).

4. Method according to claim 1, wherein the interception-related information packet (HI2/IRI; HI3/CC) is IRI information.

5. Method according to claim 1, wherein the interception-related information packet is HI3/CC information.

6. Method according to claim 1, wherein the subscriber location data service facility is a GMLC or LCS.

7. Method according to claim 1, wherein the mobile radio network is a cellular mobile radio network.

8. Device (MSC/SGSN) for monitoring (MSC/SGSN; MC) subscribers (UE) in a mobile radio network,
with a facility for requesting location data relating to subscribers (UE) to be monitored from a subscriber location data service facility (GMLC/LCS),
with a facility for inserting the location data (POS) received from the subscriber location data service facility (GMLC/LCS) into an interception-related information packet (HI2/IRI; HI3/CC),
with a facility for sending interception-related information packets (HI2/IRI; HI3/CC) to an interception center.

9. Device according to claim 7, wherein it comprises a facility for delaying the sending of an interception-related information packet (HI2/IRI; HI3/CC) to be sent until it receives location data (POS).

10. Device according to claim 7, wherein the mobile radio network is a cellular mobile radio network.
